(19) United States
(12) Patent Application Publication
(10) Pub. No.: US 2026/0208150 A1
(43) Pub. Date: Jul. 23, 2026

(54) STABLE ORGANIC COMPOSITIONS COMPRISING ZEOLITES

(71) Applicant: ARKEMA FRANCE, Puteaux (FR)

(72) Inventors: Guillaume ORTIZ, Lacq (FR); Karine LOPEZ, Lacq (FR)

(21) Appl. No.: 19/140,045

(22) PCT Filed: Dec. 13, 2023
(86) PCT No.: PCT/FR2023/051999

§ 371 Date: Jun. 17, 2025

(30) Foreign Application Priority Data
Dec. 19, 2022 (FR) 2213752

(51) Int. Cl. B01J 20/18; B01J 20/12; B01J 20/22; C08G 18/08

(52) U.S. Cl. CPC B01J 20/18; B01J 20/12; B01J 20/22; C08G 18/0885; B01J 2220/46

(57) ABSTRACT

The present invention relates to a composition comprising zeolite crystals and a hydroxylated oil stabilized by an organophilic phyllosilicate dispersant. The invention also relates to the use of said composition for drying organic compounds, compositions or solutions.

The present invention relates to the field of stable organic compositions comprising zeolites, more particularly stable liquid organic compositions comprising zeolites and most particularly stable compositions of hydroxylated organic liquids or hydroxylated organic oils comprising zeolites.

Such compositions are often and most generally used for drying organic liquids and for example polyols which can then advantageously be used for the synthesis of smooth polyurethanes, smooth polyurethanes being generally and most often intended for coatings, such as adhesives, coats and paints. Smooth polyurethanes are usually obtained by reacting said polyols with isocyanates. Specifically, it is important, often desired, or even indispensable, to prevent the water present in these polyols from reacting with the isocyanate to form carbon dioxide (CO₂) and thus create gas bubbles, or even a foam.

For instance, the U.S. Pat. No. 6,051,647, for example, seeks to improve the pot life and consequently the efficacy of a zeolite 3A. This document describes a mild acidic treatment of a zeolite 3A, in order to modify the pH thereof and thus minimize the effect of this zeolite 3A when it is used as a desiccant for manufacturing polyurethane (PU) for smooth coatings, that is to say coatings free of foaming phenomena. This document uses a 50/50 mixture of zeolite crystals and castor oil, prepared beforehand, to dry the polyol.

One of the problems encountered with such desiccant compositions relates to their low stability overtime; specifically, the zeolite crystals present in these organic compositions have a more or less pronounced tendency to sediment. The desiccant composition is then no longer homogeneous, unless said zeolite crystals are resuspended. Aside from the fact that this requires an additional mixing step, it may also be necessary to work under an inert atmosphere in order to avoid any risk of contamination by the moisture in the ambient air. All of this is reflected in additional implementational complexity, which is responsible for increased costs and energy consumption.

The U.S. Pat. Nos. 8,026,307 and 8,153,042 mention the use of phyllosilicates for two-component resins in order to avoid slump of the shapes prepared using said resins. However, these patents do not mention the use of compositions intended to introduce zeolites into the components of the resins.

Patent CN102814167 proposes an activated powder of molecular sieve in the form of a paste obtained by mixing from 48% to 52% by mass of activated powder of synthetic molecular sieve, from 30% to 52% by mass of castor oil, and from 0% to 20% by mass of a viscosity adjusting agent, generally chosen from glycols. This document teaches that the viscosity adjusting agent is present between 8% and 20%, values which are very high and may harm the quality of the desired product.

The prior art set out above demonstrates that, as of today, there is no completely satisfactory solution for stabilizing a significant amount of zeolite crystals in a hydroxylated oil in order to limit the sedimentation of said crystals.

The aim of the present invention is to provide a solution to the problems encountered in the prior art, and in particular to provide stable organic compositions comprising zeolite crystals, and in particular stable polyol compositions comprising zeolite crystals having the function of drying, desiccating said compositions.

Another aim is to provide stable liquid zeolite compositions for drying organic compounds, in particular for drying organic compounds intended for preparing 2K resins, and most particularly for drying organic compounds intended for preparing PU resins.

The inventors have now discovered that the abovementioned aims can be achieved completely or at least partly by virtue of the invention which shall now be described.

Thus, a first subject of the present invention relates to composition comprising:
from 30% to 70%, preferably from 40% to 60%, by weight, relative to the total weight of the composition, of at least one hydroxylated oil,
from 70% to 30%, preferably from 60% to 40%, by weight, relative to the total weight of the composition, of crystals of at least one zeolite, and
from 0.1% to 5%, preferably from 0.3% to 1.5%, by weight, relative to the total weight of the composition, of at least one dispersant of organophilic phyllosilicate type,
   it being understood that the sum of the three components of the composition defined above reaches 100%.

For the purposes of the present invention, the term “hydroxylated oil” is understood to mean any fatty organic compound comprising at least one hydroxyl function, and for example hydroxylated fatty acid esters, such as for example mono-, di- and triglycerides, alone or as mixtures of two or more thereof. According to one embodiment of the invention, the hydroxylated oil is chosen from mono-, di-, tri- and polyhydroxylated oils, alone or as a mixture of two or more thereof.

Mention may be made, as a nonlimiting example of hydroxylated oils that are able to be used in the composition of the invention, of castor oil naturally possessing hydroxyl functions. It is also possible to envisage using any other type of hydroxylated oil or mixtures of hydroxylated oils, obtained from vegetable, animal or mineral oils, such as for example from soybean, palm, sunflower, olives, and others.

The composition according to the present invention also comprises crystals of at least one zeolite. Zeolites are mineral compounds that are well known to those skilled in the art and may be natural, artificial or synthetic zeolites. Zeolites are crystalline aluminosilicates, the crystal structure of which depends, inter alia, on the silicon/aluminum (Si/Al) molar ratio.

The zeolites, in the form of crystals, which can be used in the context of the present invention, may be of any type. By way of nonlimiting examples, the zeolites are chosen from zeolites of LTA, FAU, MFI, CHA, SOD, GIS, MOR, RHO, EMT and LTL type, preferably from zeolites of LTA, FAU and MFI type and more preferably from zeolites of LTA and FAU type. In a variant, the zeolites are chosen from zeolites of MFI type. As already indicated above, the composition of the present invention may comprise crystals of one or more zeolites, depending on the effect sought.

The zeolite crystals used in the context of the present invention have advantageously undergone beforehand one or more treatments aimed at reducing the residual water content, or even eliminating the free and adsorbed water, or at eliminating any organic structuring agents used during the synthesis of said crystals. Such treatments are known perfectly well to those skilled in the art and include heat treatments, vacuum degassing, vacuum desorption, and others. The residual water content of the zeolite crystals used in the invention is determined by the Karl Fischer method. Preference is given to zeolite crystals having a residual water content of less than 1% by weight.

According to a preferred embodiment, said at least one zeolite of the composition of the present invention is chosen from the zeolites of LTA type and of FAU-X type, and, from among these, preference is given to those the Si/Al molar ratio of which is between 1.0 and 1.5, limits included.

According to yet another embodiment, said at least one zeolite of the composition of the present invention is chosen from the zeolites 3A, 4A, 5A and 13X. According to another embodiment, said at least one zeolite of the composition of the present invention is chosen from the MFIs, in particular the zeolites of Silicalite-1 type.

The size of the zeolite crystals may vary within wide proportions. However, for the purposes of the present invention, preference is given to zeolite crystals having a size of between 0.1 μm and 5 μm, preferably between 0.5 μm and 4 μm, limits included. The size of the crystals corresponds to the number-average diameter, calculated by counting in scanning electron microscopy (SEM) images.

The composition according to the present invention is characterized by the fact that it comprises at least one dispersant. Without wishing to be bound by theory, the dispersant promotes and/or makes it possible to keep the zeolite crystals in suspension in the hydroxylated oil. Said at least one dispersant used in the composition of the present invention is an organophilic phyllosilicate.

Phyllosilicates are natural or synthetic minerals from the group of the silicates, constructed by the stacking of tetrahedral layers, where the tetrahedra share three out of four vertices, the fourth vertex being connected to an octahedral layer occupied by different cations, for example aluminum, magnesium, iron, titanium, lithium cations, and others.

The phyllosilicates that can be used to form the organophilic phyllosilicates that are the dispersants of the composition of the present invention may be of any type and in particular natural clays in general, among which mention may be made of bentonites, palygorskites, sepiolites, attapulgites, montmorillonites, hydrotalcites, octasilicates, and others, and mixtures of two or more thereof in any proportions. According to a preferred embodiment, the phyllosilicate is chosen from fibrous clays and preferably from hormites, the main representatives of which are sepiolite and attapulgite (or palygorskite). Sepiolite and attapulgite are the preferred hormites in the context of the present invention, and entirely preferably the preferred phyllosilicate is sepiolite.

Organophilic phyllosilicates, also known as organoclays, are generally prepared from natural phyllosilicates that are modified by one or more chemical treatments, generally using an organic compound, usually of surfactant type, for example a nitrogen-containing surfactant, to render them organophilic, as is described, for example, in the patent application WO1999042518. Among the organic compounds suitable for modifying the phyllosilicates that can be used in the context of the present invention, preference is given to cationic surfactants, among which mention may be made in particular of compounds of quaternary ammonium type, as described, for example, in US20200181474.

According to a preferred embodiment of the invention, said at least one dispersant is an organophilic phyllosilicate chosen from bentonites, palygorskites, sepiolites, attapulgites, montmorillonites, hydrotalcites, octasilicates, and preferably chosen from hormites, with preference among these being given to sepiolite, said organophilic phyllosilicate being surface-functionalized with one or more compounds chosen from amines, surfactants, silanes, siloxanes and alkyl chains. Mixtures of one or more organophilic phyllosilicates may be used in the composition of the present invention. More preferably, said at least one dispersant is a fibrous clay or a mixture of fibrous clays modified with one or more surfactants.

Organophilic phyllosilicates are well known to those skilled in the art and already widely used in many fields of application; representatives of these compounds are sold, for example, by the company BYK under the general names TIXOGEL®, CLAYTONE® or GARAMITE®.

It has been discovered, completely surprisingly, that the presence of at least one dispersant of organophilic phyllosilicate type makes it possible to greatly limit the sedimentation of zeolite crystals present in a hydroxylated oil, in particular when said crystals are present in an amount of greater than 30%, preferably greater than 40%, preferably greater than 50%, by weight, limits included, even after several months of storage.

The advantages associated with this great limitation, or even the absence, of sedimentation offer a great many advantages, among which mention may in particular be made of the lack of the need to redisperse the zeolitic adsorbent crystals in the oil, which would entail bringing the oil into contact with ambient air laden with a more or less significant amount of water vapor that might contaminate the dispersion. As a result, the composition of the invention is consequently absolutely advantageous in many fields of application. By way of example, the composition of the present invention allows polyurethane manufacturers to use the composition (hydroxylated oil/zeolite crystals) in their formulation without needing to redisperse the zeolite crystals in the oil.

The composition described in this invention can be prepared by any means known per se, and for example by simple mixing of its various constituents with one another. According to a preferred embodiment, the zeolite crystals are added to the hydroxylated oil under shearing stirring at a quick rate, for example of the order of 1500 rpm, using a shearing stirrer, for example of the Rayneri type, and then, still under stirring, the dispersant is added. The dispersant may advantageously be added in the form of a mixture in an oil, for example the hydroxylated oil of the composition of the invention.

After completely homogenizing the mixture of the constituents, the composition may advantageously be degassed in order to remove the bubbles of air trapped during the preparation of the composition, according to any means known per se, and for example by gentle heating (for example between 40° C. and 80° C.) under partial vacuum, for example under 0.2 bar (0.2 kPa). This degassing step is advantageously performed under stirring, preferably gentle stirring, for example of the order of 200 rpm, until complete or virtually complete degassing is achieved. The composition according to the invention is then in the form of a homogeneous paste, with suspended and well-dispersed zeolite crystals.

According to a second aspect, the invention relates to the use of the composition as has just been defined for drying organic compounds, compositions or solutions. According to a most particularly preferred aspect, the invention relates to the use of the composition as has just been defined for drying organic compositions intended for preparing 2K resins, and more particularly still for drying organic compositions intended for preparing polyurethane resins.

Lastly, and according to a particularly advantageous aspect, the composition of the present invention is entirely suitable for use in drying polyol compositions intended for preparing polyurethane resins.

As indicated previously, the composition according to the invention exhibits entirely surprising stability, without sedimentation, or at the very least without excessive sedimentation, during transport and storage in a container, for durations ranging up to one month, or even up to two months, or even up to three months and even up to 4 months or more.

The time from which the sedimentation of the zeolite crystals in the hydroxylated oil is observed can be determined by an accelerated test carried out in a centrifuge. The percentage of settling of the zeolite crystals in the paste is measured by taking the ratio of the apparent height of the hydroxylated oil to the total height of the mixture.

The invention will now be illustrated with the aid of the following examples without, however, limiting the scope of protection thereof defined by the appended claims. The physical properties, methods and analytical tests described in the examples are evaluated by the methods known to those skilled in the art, the main ones of which are reiterated below.

### Characterization Techniques

The number-average diameter of the zeolite crystals is estimated by observation with a scanning electron microscope (SEM). In order to estimate the size of the zeolite crystals in the samples, a set of images is acquired at a magnification of at least 5000. The diameter of at least 200 crystals is then measured using dedicated software, for example the Smile View software published by LoGraMi. The precision is of the order of 3%.

In the examples that follow, several organophilic phyllosilicates of various natures were evaluated for their dispersing properties. All of the compositions of zeolite crystals in a hydroxylated oil are prepared and evaluated according to example 1 below.

### EXAMPLE 1: TEST WITHOUT DISPERSANT

A mixture containing 50% by weight of zeolite crystals and 50% by weight of hydroxylated oil is prepared. To this end, 250 g of SA 1720 SC zeolite crystals (type 3A zeolite, sold by the company Arkema) with a d₅₀ particle size=2.5 μm (number-average diameter) are introduced into 250 g of castor oil, under shearing stirring, at a quick rate, using a Rayneri mixer at 1500 rpm, in a plastic pot. A homogeneous paste of approximately 500 g is obtained. In order to remove the bubbles of air trapped in the paste during its preparation, the paste is heated at 60° C. under vacuum (0.2 kPa) under gentle stirring (200 rpm) for 1 hour. A homogeneous paste with suspended and well-dispersed crystals is obtained.

In order to evaluate the time from which the sedimentation of the zeolite crystals in the castor oil is observed, an accelerated test is carried out in a Sigma 6K15 model centrifuge. To do this, 3 flasks containing 140 g of paste are distributed in the centrifuge and set rotating at 3000 RCF (Relative Centrifugal Force) for 30 min. The settling of the zeolite crystals in the paste is measured by taking the ratio of the apparent oil height in mm/total height of the mixture in mm and given as a percentage. The degree of sedimentation of this composition without dispersant is 18%.

In examples 2 to 9, dispersants of various natures are evaluated. All of the compositions of the following examples are prepared and evaluated in the same way. The results are collated in table 1, which appears later in the description.

### EXAMPLE 2: COMPOSITION ACCORDING TO THE INVENTION

A composition is prepared as described above in example 1. A mixture containing 49.75% by weight of zeolite crystals and 49.75% by weight of hydroxylated oil is prepared, to which 0.5% of dispersant is added. To this end, 250 g of zeolite of example 1 are introduced into 125 g of castor oil, under shearing stirring, at a quick rate, using a Rayneri mixer at 1500 rpm, in a plastic pot. Then, under stirring for 30 min, 2.51 g of dispersant, dispersed beforehand in 125 g of castor oil, is added. The dispersant is an organophilic montmorillonite, sold under the reference CLAYTONE® AF by the company BYK.

A homogeneous paste of approximately 502.5 g is obtained. In order to remove the bubbles of air trapped in the paste during its preparation, the paste is heated at 60° C. under vacuum (0.2 kPa) under gentle stirring (200 rpm) for 1 hour. A homogeneous paste with suspended and well-dispersed crystals is obtained. The degree of sedimentation of the composition of example 2 is 8.9%.

### EXAMPLE 3: ACCORDING TO THE INVENTION

In this example, in which the composition is prepared as in example 2, the dispersant is an organophilic montmorillonite sold under the reference TIXOGEL® MP 250 by the company BYK. The degree of sedimentation is 8.0%.

### EXAMPLE 4: ACCORDING TO THE INVENTION

This composition is also prepared as in example 2, but with the dispersant being replaced by an organophilic sepiolite sold under the reference GARAMITE® 1958 by the company BYK. The degree of sedimentation is 6.9%.

### EXAMPLE 5: COMPARATIVE EXAMPLE

This composition is prepared according to example 2, with, as dispersant, a dispersant of modified polyalkylene imine polyglycol polyester type, sold under the reference BYK® 2155 by the company BYK. The observed degree of sedimentation is 11.9%.

### EXAMPLE 6: COMPARATIVE EXAMPLE

In this composition, prepared as in example 2, the dispersant this time is a dispersant of acid-group-functionalized copolymer type, and sold under the reference DISPERBYK® 111 by the company BYK. The degree of sedimentation is then 22%.

### EXAMPLE 7: COMPARATIVE EXAMPLE

Still preparing the composition according to the protocol of example 2, the composition of this example contains a dispersant which is a modified urea solution, sold under the reference DISPERBYK® 7410 by the company BYK. The degree of sedimentation is then 13%.

### EXAMPLE 8: COMPARATIVE EXAMPLE

The composition of comparative example 8 is prepared according to the protocol of example 2 with a dispersant of high-molecular-mass polyacrylic type, sold under the reference BYK® 430 by the company BYK. The degree of sedimentation is 12.1%.

### EXAMPLE 9: COMPARATIVE EXAMPLE

In this comparative example, the composition is prepared according to the protocol of example 2 with a clay of unmodified sepiolite type, sold under the reference P400 by the company Tolsa. The degree of sedimentation is 17.5%.

All of the results are collated in table 1 below.

TABLE 1

| | | Degree of |
|---|---|---|
| Example | Dispersant | sedimentation |
| 1 (blank) | — | 18% |
| 2 (invention) | CLAYTONE ® AF | 8.9% |
| | (BYK) | |
| 3 (invention) | TIXOGEL ® (BYK) | 8.0% |
| 4 (invention) | GARAMITE ® 1958 | 6.9% |
| | (BYK) | |
| 5 (comparative) | BYK ® 2155 (BYK) | 11.9% |
| 6 (comparative) | DISPERBYK ® 111 | 22% |
| | (BYK) | |
| 7 (comparative) | DISPERBYK ® 7410 | 13% |
| | (BYK) | |
| 8 (comparative) | BYK ® 430 (BYK) | 12.1% |
| 9 (comparative) | P400 (Tolsa) | 17.5% |

The results above clearly show that the dispersants of organophilic phyllosilicate type make it possible to substantially reduce the degree of sedimentation of compositions of zeolite crystals dispersed in a hydroxylated oil. In contrast, when the dispersant is a dispersant other than an organophilic phyllosilicate, the sedimentation becomes significant or even problematic, and may require rehomogenization before use.

1. A composition comprising:
(a) 30% to 70%, by weight, relative to the total weight of the composition, of at least one hydroxylated oil,
(b) 70% to 30%, by weight, relative to the total weight of the composition, of crystals of at least one zeolite, and
(c) 0.1% to 5%, by weight, relative to the total weight of the composition, of at least one dispersant of organophilic phyllosilicate type, and
wherein the sum of the weight percent of (a) (b) and (c) is 100%.

2. The composition of claim 1, wherein the hydroxylated oil is a di-, tri- or polyhydroxylated oil, alone or as a mixture of two or more thereof.

3. The composition of claim 1, wherein the hydroxylated oil is a hydroxylated oil or a mixture of hydroxylated oils, obtained from vegetable, animal or mineral oils.

4. The composition of claim 1, wherein said at least one zeolite is one or more zeolites of type LTA, FAU, MFI, CHA, SOD, GIS, MOR, RHO, EMT and LTL.

5. The composition of claim 1, wherein said at least one zeolite is selected from the group consisting of one or more zeolites of LTA type and of FAU-X type, wherein the Si/Al molar ratio of which is 1.0 to 1.5.

6. The composition of claim 1, wherein said at least one zeolite is selected from the group consisting of zeolites 3A, 5A and 13X, and combinations thereof.

7. The composition of claim 1, wherein the zeolite crystals have a number-average diameter, calculated by counting in scanning electron microscopy (SEM) images, of 0.1 μm to 5 μm.

8. The composition of claim 1, wherein the dispersant is an organophilic phyllosilicate selected from the group consisting of: bentonites, palygorskites, sepiolites, attapulgites, montmorillonites, hydrotalcites, octasilicates, said organophilic phyllosilicate being surface-functionalized with one or more compounds selected from the group consisting of: amines, surfactants, silanes, siloxanes and alkyl chains.

9. The composition of claim 1, wherein the dispersant is a fibrous clay or a mixture of fibrous clays modified with one or more surfactants.

10. A method of drying organic compounds, compositions or solutions, comprising contacting said compounds, compositions or solutions with a composition of claim 1.

11. (canceled)

12. (canceled)

13. (canceled)

14. The composition of claim 3, wherein the hydroxylated oil is castor oil.

15. The composition of claim 4, wherein the at least one zeolite is selected from the group consisting of zeolites of type LTA, FAU, and MFI, and combinations thereof.

16. The composition of claim 7, wherein the zeolite crystals have a number-average diameter, calculated by counting in scanning electron microscopy (SEM) images, of 0.5 μm to 4 μm.

17. A composition comprising:
(a) 40% to 60%, by weight, relative to the total weight of the composition, of at least one hydroxylated oil,
(b) 60% to 40%, by weight, relative to the total weight of the composition, of crystals of at least one zeolite, and
(c) 0.3% to 1.5%, by weight, relative to the total weight of the composition, of at least one dispersant of organophilic phyllosilicate type,
wherein the sum of the weight percent of (a) (b) and (c) is 100%.
